(19) United States
(12) Patent Application Publication
(10) Pub. No.: US 2018/0089823 A1
(43) Pub. Date: Mar. 29, 2018

(54) ASSET MANAGEMENT SYSTEM

(71) Applicant: ESCO Corporation, Portland, OR (US)

(72) Inventors: Christopher M. Carpenter, Tualatin, OR (US); Paul L. Heaphy, Wellington Point (AU); Eric E. Wilkinson, Happy Valley, OR (US)

(21) Appl. No.: 15/713,460

(22) Filed: Sep. 22, 2017

Related U.S. Application Data
(60) Provisional application No. 62/398,880, filed on Sep. 23, 2016.

(51) Int. Cl. G06T 7/00; G07C 5/00; G06F 3/0488; G06F 3/0484

(52) U.S. Cl. CPC G06T 7/0004; G07C 5/006; G06F 3/04883; G06F 3/0482; G06T 2207/30164; G06T 2207/10004; G06F 3/04845

(57) ABSTRACT

A system and process for managing a capital product for earth working equipment includes utilizing a mobile device to inspect, analyze and/or document the condition of the capital product for a mine or construction operation that is exposed and/or subjected to circumstances that can lead to wear or damage such as for a bucket associated with earth working equipment. The system and process can include inspecting the capital product to identify an issue on the capital product, displaying an image of the capital product on a screen of a mobile device, placing an electronic symbol on the screen with the image to indicate where the identified issue is located on the capital product, and electronically storing the image with the symbol.

### TECHNICAL FIELD

The present disclosure relates to systems and methods for inspecting, analyzing and/or documenting the condition of a capital product for a mine or construction operation that is exposed and/or subjected to circumstances that can lead to wear or damage.

### BACKGROUND OF THE INVENTION

Earth working equipment (e.g., hydraulic excavators, wheel loaders, etc.) are commonly used in mining and construction operations. Such equipment typically has a bucket that includes a digging edge to penetrate the ground and a containment cavity for gathering earthen material. The buckets can be subjected to abrasive conditions, heavy loading, corrosive materials, impacts and/or other deleterious circumstances during use. As a result, they can over time suffer from wear, cracking, etc., and be in need of maintenance and/or repair. Site inspectors for ground engaging tools are often tasked with keeping track of the condition of the buckets. Such inspections are generally done with the inspector manually taking notes on paper or by retaining the inspection by memory. The notes or memory are then transcribed or documented at a later time, typically back in an office. Notes taken by inspectors are too often incomplete or indecipherable, and reliance on memory tends to lack the desired reliability. Additional administrative work is generally required at the office to document the bucket's condition, summarize data for reporting, and/or predict when to initiate maintenance and/or repair of a bucket. Accordingly, current practices can lead to various problems including, for example, inefficiencies, incomplete assessments and documentation, extra costs, necessary work being overlooked, unnecessary work being conducted, etc.

### SUMMARY OF THE INVENTION

The present disclosure relates to systems and processes for utilizing a mobile device to inspect, analyze and/or document the condition of a capital product for a mine or construction operation that is exposed and/or subjected to circumstances that can lead to wear or damage such as for a bucket associated with earth working equipment. These systems and processes can improve decision making for parts management and equipment maintenance, reduce work required to perform inspections, improve work efficiencies, improve asset management compliance, lengthen useful life of the capital equipment, and/or improve maintenance planning.

In one embodiment, a process for managing a capital product for an earth working operation includes inspecting the capital product to identify an issue on the capital product, displaying an image of the capital product on a screen of a mobile device, placing an electronic symbol on the screen with the image to indicate where the identified issue is located on the capital product, and electronically storing the image with the symbol.

In another embodiment, a process for managing a capital product includes displaying an image of the capital product on a screen of a mobile device, inspecting the capital product to identify an issue on the capital product, and providing a symbol on the image. The symbol is located on the image of the capital product at a location that corresponds to the location of the issue on the capital product. The mobile device is used to input at least one characteristic of the issue associated with the symbol on the image. The image with the symbol and the characteristic are electronically stored for later use.

In another embodiment, a process for managing of a capital product includes inspecting the capital product to identify an issue on the capital product, displaying an image of the capital product on a screen of a mobile device, providing a symbol on the image, and inputting at least one characteristic of the issue. The image and the characteristic are used to identify the location and nature of the issue on the capital product and make a determination of work to be made on the capital product.

In another embodiment, a process for managing a capital product includes taking a photograph of the capital product and displaying the photographic image on a screen of a mobile device. A symbol is electronically placed on the image by the user to correspond to an issue (e.g., wear or damage) identified during inspection of the capital product.

In another embodiment, a system for inspecting a capital product includes a mobile device with a screen and a processor having programmable logic to display an image of the capital product on the screen. A human machine interface is provided to input information for use by the processor to (i) display a symbol on the image at a location on the image that corresponds to the location of an issue on the capital product, and (ii) associate a characteristic of the issue with the symbol. A storage medium electronically stores the image with the symbol and the information regarding the characteristic for later use.

In another embodiment, a mobile device is used to document critical observations regarding the condition of a capital product (e.g., a bucket) including, for example, wear, damage and/or fitness for use. The mobile device provides the inspector with information on the product, receives data or other information from the inspector on the bucket's condition, and facilitates or assists in documenting the condition for maintenance, repair, analytics, scheduling, assessing, archiving, etc. These systems and processes can improve the efficiencies and/or costs associated with maintaining the product, and/or documenting the maintenance and repair history.

In another embodiment, a mobile device provides a step-by-step process of review to better provide completeness, reliability, efficiency and/or ease for the inspector. The inspector can rely on information provided by the mobile device in lieu of notes or memory to better obtain a more complete and/or reliable inspection, maintenance, repair and/or documentation.

In another embodiment, a process for managing a capital product for an earth working operation includes using a mobile device to communicate instructions for inspecting the capital product, inspecting the capital product by following the instructions to identify issues on the capital product, displaying at least one image of the capital product on a screen of the mobile device, placing an electronic symbol on the screen with the image to indicate where the identified issue is located on the capital product, and electronically storing the image with the symbol for later use.

In another embodiment, a mobile device provides an image of the bucket or other capital product to be inspected and a touchscreen display for the inspector to touch the image to place a symbol on the image that corresponds to a noted issue (e.g., wear, crack, etc.) on the inspected product. The placement of a symbol on an image of the product can make it easy, e.g., for the inspector to identify the location of the issue, a shop worker to identify which part of the product needs maintenance and/or repair, and/or a manager to assess the history of the product for assessing and/or scheduling associated to operations.

In another embodiment, preset data is provided to or by a mobile device to assist full identification and characterization of the issues noted during the inspection. In one embodiment, drop down lists and/or easy touchscreen input of the nature of the issues (e.g., wear, damage and/or other conditions) and severity (e.g., severe, medium and/or monitor) are available for speed, ease, completeness and/or reliability of the inspections and/or actions to be taken (e.g., repair and/or maintenance). The inspector may, optionally, also have the capability to independently enter data, comments, photos and/or other information.

In another embodiment, a system including a mobile device gathers, aggregates, processes and/or documents wear, cracking, damage and/or other conditions during a single inspection, multiple inspections and/or inspections of capital products (e.g., buckets) at multiple sites. These systems and processes can assist the user in assessing operations, efficiencies, costs, longevity and/or operator actions, schedule maintenance and/or repair, and/or making more efficient use of equipment for selected locations and/or operations.

In another embodiment, a system including a mobile device may allow user input (issue, position, etc.), utilize device data (time stamp, location, etc.) and capture data (e.g., images, video, etc.) related to a capital product (e.g., a bucket), analyze the input, and/or manage the maintenance and/or repair of the inspected product.

In another embodiment, a system including a mobile device may store annotated images of capital products (e.g., a bucket) associated with the products to be inspected. In one embodiment, the information received through the mobile device may facilitate and/or generate one or more reports related to the condition (e.g., wearing, fitness, etc.) of the product. Further, in one embodiment, the system may provide alerts for an end-of-life situation for a component or the entire product is approaching.

In another embodiment, an application stored on a mobile device may be used to capture pertinent data related to the condition of a capital product. A central wear part management server may capture pertinent data across a job site and manage maintenance, repair and/or replacement.

Further aspects of the disclosure may be provided in a computer-readable medium having computer-executable instructions that, when executed, cause a computer, user terminal, or other apparatus to at least perform one or more of the processes described herein.

The various aspects and features of the embodiments can be used independently or collectively with all or some of the different aspects or features of the invention. The above noted embodiments are exemplary summary observations of certain ideas of the various concepts of the invention and are not intended to be exhaustive or essential. To gain an improved understanding of the advantages and features of the invention, reference may be made to the following description and accompanying figures that describe and illustrate various configurations and concepts related to the invention.

### BRIEF DESCRIPTION OF THE DRAWINGS

FIG. 1 is a perspective view of a bucket.

FIG. 2 is a top view of a mobile device.

FIGS. 3-12 are images of a bucket on a display of a mobile device.

### DETAILED DESCRIPTION OF PREFERRED EMBODIMENTS

The present disclosure relates to systems and methods for utilizing a mobile device to improve inspections, analysis and/or reporting with respect to capital products for mining and construction operations. Such systems and methods can improve decision making for parts management and equipment maintenance, reduce work required to perform inspections, increase work efficiencies, improve asset management compliance, lengthen useful life of the products, enhance operations, and/or improve maintenance planning.

Buckets are a common capital product used in arduous conditions in mining and construction. Buckets are used with a wide variety of earth working equipment including, for example, hydraulic excavators, wheel loaders, cable shovels, face shovels, dragline machines, bucket-wheel excavators, etc. The buckets are often exposed to abrasive materials, heavy loading, corrosive materials, impacts and/or other deleterious conditions. As a result, over time, they tend to suffer wear, cracking, damage, etc., and be in need of maintenance, repair and/or replacement. Buckets can be a large capital expense, and proper maintenance and repair can lead to longer life, enhanced production and/or reduced costs. Notwithstanding the importance of maintaining excavating buckets, bucket inspection has too often been incomplete, haphazard, unreliable and/or time consuming.

For ease of discussion, this application generally discusses processes and systems in connection with one bucket for a hydraulic excavator. However, the invention is not so limited. For example, the disclosed systems and processes could be used to inspect other kinds of buckets for hydraulic excavators and/or buckets for other kinds of earth working equipment (e.g., wheel loaders, cable shovels, face shovels, dragline buckets, etc.). The processes and systems can also be used to inspect, maintain, repair and/or document other capital products in mining and construction (e.g., truck trays, ore chutes, etc.).

Relative terms such as front, rear, top, bottom and the like are used for convenience of discussion. As one example, in connection with a bucket, the terms front or forward are generally used to indicate the usual direction of travel of the bucket relative to the earthen material it engages during use (e.g., while digging). Nevertheless, it is recognized that in mining and construction operations capital products (such as buckets secured to earth working equipment), may be oriented in various ways, move in all kinds of directions, and/or contact earthen material in all kinds of ways during use. Similarly, the numerical terms such as first, second and so on are exemplary only to ease discussion of the processes and systems, and are not intended to be limiting as to a particular order.

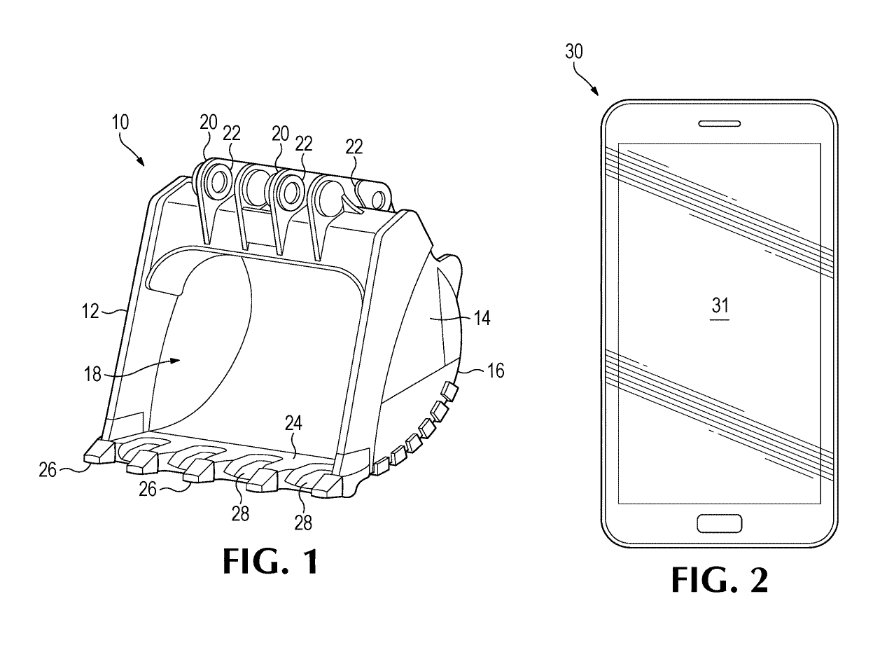

In one embodiment, bucket 10 includes sidewalls 12, 14 and a concave rear wall 16 welded together to define a containment cavity 18 for receiving earthen material (FIG. 1). Coupling flanges 20 with holes 22 are provided at the upper end of rear wall 16 for attaching the bucket to the stick of an excavator (not shown). A lip 24 forming a digging edge is provided along the front edge of rear wall 16. Ground engaging tools 24, 26 in the form of teeth and shrouds are secured to the lip. The lower portions of sidewalls 12, 14 also form a part of the digging edge and may include ground engaging tools (e.g., shrouds), though none are provided on the sidewalls of bucket 10. During use, a bucket may wear, crack and/or be damaged in one or more ways due to the arduous nature in which they generally operate. Periodic inspections can be conducted to assess the condition of the bucket and determine fitness, usable life and/or the need for maintenance and/or repair.

In one embodiment, a mobile device 30 is used in association with the inspection of a bucket (FIG. 2). The mobile device can be any of a variety of devices including a mobile telephone, tablet, custom device, etc. Preferably the mobile device is provided with an app to facilitate and/or coordinate the inspection, analysis and/or documenting of the condition of the bucket. The mobile device may be preloaded with the desired information and/or connect to a portal or website having the desired information.

The mobile device may include a storage medium, a processer with programmable logic, an electronic visual display and/or a human machine interface (e.g., user input means) to accomplish the desired processes. Alternatively (or in addition), the mobile device may connect for example to a remote processor with programmable logic to implement the desired processes. It may also include a communication device to communicate (wireless or wired) with various other machines (e.g., a PC at a remote office) through networks or other communication means. Such network connections can include a local area network (LAN), a wireless local area network (WLAN), a wide area network (WAN) and/or wireless wide area network (WWAN), but may also include other networks. When used in a WLAN or LAN networking environment, the server can be connected to the WLAN or LAN through a network interface or adapter. When used in a WAN networking environment, the server may include a modem or other means for establishing communications over the WAN, such as the Internet. The Internet may also represent an intranet or a cloud environment. The WWAN may rely on a mobile telecommunication cellular network or other known connections. The network connections are illustrative and other means of establishing communications links between the computers may be used. Various protocols such as TCP/IP, Ethernet, FTP, and HTTP may be used in establishing the communications links. The mobile device can include a variety of elements to facilitate the desired processes including, for example, a receiver, transmitter, storage medium, GPS device, camera, timekeeper, microphone, display, keyboard and/or microprocessor with programmable logic.

Mobile device 30 may communicate with a remote device, which is located apart from the mobile device. A remote device could be on the inspected bucket, the machine to which the bucket is attached, a service truck, drone, another handheld device, station, home office, etc. A single remote device may be used or a collection of remote devices working together or separately may be used. As examples, a remote device may include a processer (PC, microprocessor, etc.), a database, a transmitter, a receiver, etc. The remote device may communicate with other mobile devices and/or with a database and/or computer. The remote device, for example, may be a wireless device or a wired device.

Mobile device 30 and the remote device can be designed to communicate with each other in different ways and no one particular way is needed. For example, the mobile device 30 could be designed to only transmit information and the remote device designed to receive the information from the mobile device 30. In other examples, the mobile device 30 and the remote device could be designed to communicate back and forth with each other. The communication may use various communication protocols, for example, without limitation, continuous, intermittent, event driven, on demand, or batch communication. The information can be received and processed historically or as a real-time assessment. As an example, the mobile device may automatically send the collected information to a remote device when entered. As another example, the mobile device may send the collected information when directed to do so by the user. As another example, if the signal is only available during certain times, the remote device can receive batch information of all the information detected when the signal could not be accessed. As another example, the user may download the information to a remote device when returning to the office. These examples are not intended to be limiting.

In one example, a user has a mobile device 30 that includes a screen or electronic visual display 31 and a human machine interface, which in this embodiment is a touchscreen on the electronic visual display 31 for user input. The bucket to be inspected can be identified and input into the system by various means including, for example, manual input by the user (e.g., through touchscreen and/or keyboard), wireless communication with the bucket, wear parts or machine (via a sensor, transmitter, etc.), scanning a code or other indicia on the bucket or machine, wireless communication from a remote location, and/or prior inputted data. As examples only, the system may capture the bucket location (e.g., by manual entry, GPS, etc.), the earth working equipment to which the bucket is attached, identification of the bucket, a service meter reading, and/or a date the information is entered. The information gathered on the equipment can include other information as well including, for example, the type, size, brand, and/or identification number of the bucket and/or machine. Further, other information can also be included such as a past history of inspections, service provider, manufacturer, hours of use, last date of maintenance or repair, etc.

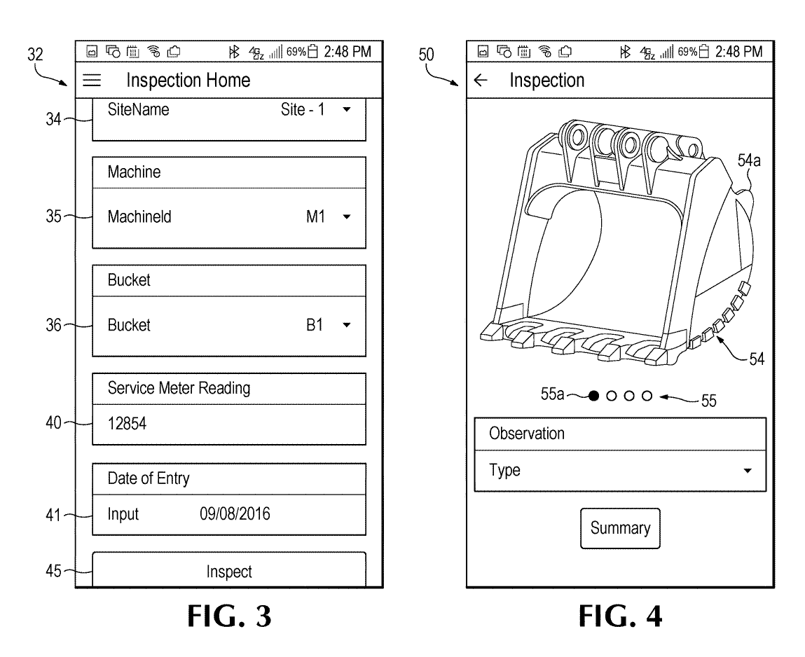

As an example only, a manual entry process can be used. In this embodiment, a touchscreen display 31 is used. To begin an inspection process, the user, for example, initiates the app to bring up screen image 32 on the display as shown in FIG. 3. Screen image 32 includes three drop down lists 34-36 with preset information and two windows 40-41 for entering information. The first drop down list 34 is called “site name” and includes a listing of the various locations where a bucket may be inspected by the user. In this example, the user can choose one of the three options provided: a site-1, site-2 and general. Other numbers of options and/or different options could be provided. The user selects one of the selections through the touchscreen. Selecting “general” opens a window and a keyboard on the display (not shown) for manual entry of a site not included in the preset information. Entry may also be through other means such as a microphone or scanning a code. Screen image 32 includes a second drop down list 35 for selecting the earth working equipment to which the bucket is attached, and a third drop down list 36 for selecting the inspected bucket. Screen image 32 includes two windows for entering information including a first window 40 for entering the service meter reading, and a second window 41 for entering the date of entry of the information. In this example, touching the window brings up a keyboard for entering the information, though other means could be used. The date of entry could be entered automatically, by touching the window or entered by other means. Screen image 32 in this example also includes an inspect button 45, which starts the inspection process. Touching the inspect button 45 initiates the inspection process and takes the user to the screen image 50 (FIG. 4).

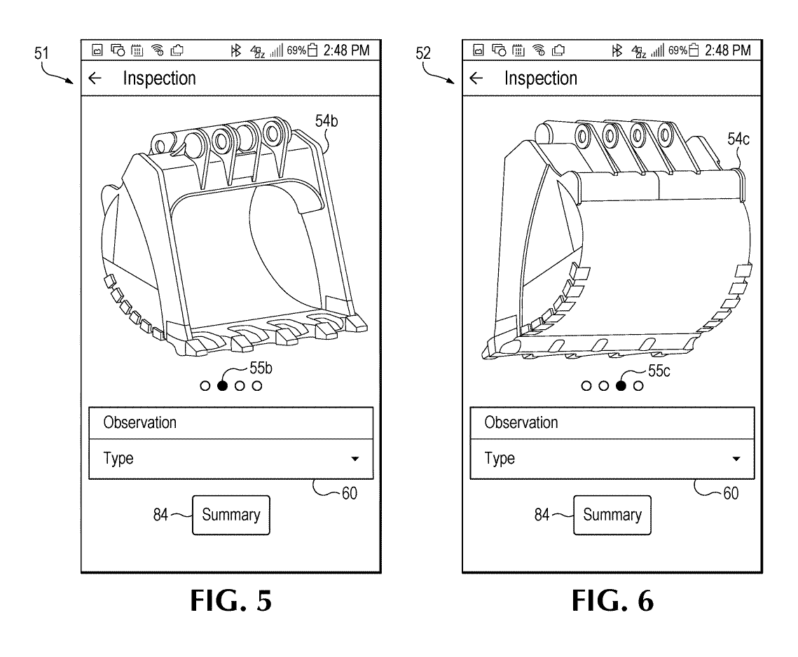

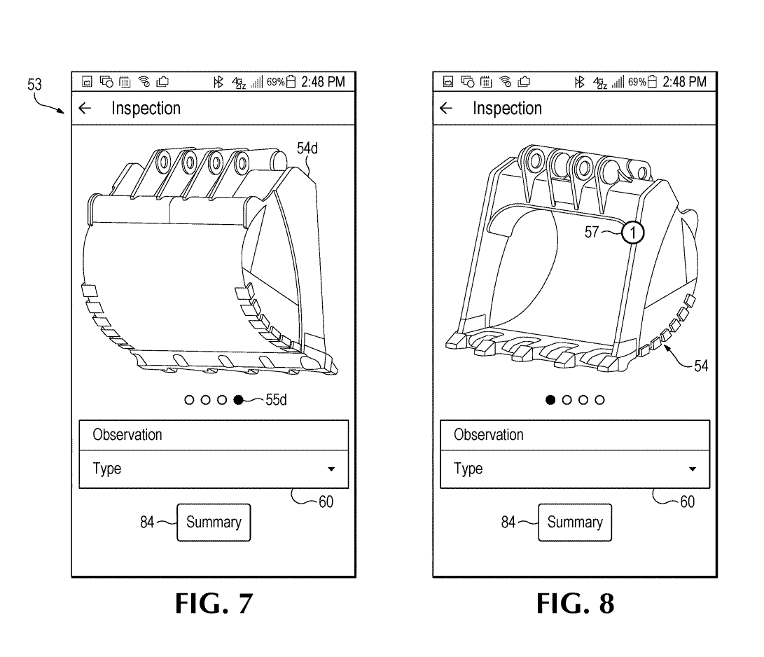

In this example, different images of bucket 10 are shown in sequential screen images 50-53 on the display (FIGS. 4-7). In one embodiment, the images are preset drawings of the bucket to be inspected. In this example, four preset product images 54 are provided: (1) a bucket image 54a showing a front, left-facing, perspective view of the bucket (FIG. 4), (2) a bucket image 54b showing a front, right-facing, perspective view of the bucket (FIG. 5), (3) a bucket image 54c showing a rear, left-facing, perspective view of the bucket (FIG. 6), and (4) a bucket image 54d showing a rear, right-facing perspective view of the bucket (FIG. 7). Nevertheless more or different views of the bucket could be shown on the display including, for example, front, top, side or partial views of the bucket. The images could optionally be expanded or shrunk by spreading of closing fingers on the touchscreen. Close up portions of the bucket could also be included as separate images. In this example, the bucket images 54 are displayed sequentially by the user swiping the display to move from image to image, though other ways of moving between the images could be used. In the figures, four display dots 55 are provided on screen images 50-53 to indicate four total bucket images and which image is on the display. In this example, the first display dot 55a is shown highlighted in screen image 50 to indicate bucket image 54a is shown on the display (FIG. 4). The second display dot 55b is highlighted in connection with bucket image 54b (FIG. 5), the third display dot 55c is highlighted for bucket image 54c (FIG. 6), and the fourth display dot 55d is highlighted for bucket image 54d (FIG. 7). Other image or screen indicators could be used or none could be used.

The present images may be for the specific bucket to be inspected (e.g., based on the inputted information on screen image 32) or could be generalized images of a bucket. The preset images can have virtually any form including, e.g., line drawings, computer-generated images and/or photographs. The preset images could be electronically stored in the mobile device or accessed from a remote database. The images may also be provided by the user. For example, the mobile device can include a camera to take photographs of different views of the bucket (and/or adapted to receive photographs from a separate camera) to be used in the inspection process. For example, the user can take photographs of the bucket to be inspected at each of the four views shown in screen images 50-53 (and/or other views) instead of using preset images of the bucket. The mobile device may be set up to use only preset images or photographs, or may allow either or both to be used. When photographs are taken for the images, the mobile device can be set up such that the user is prompted at screen image 50 to take a photograph, which is then automatically used as the bucket image on that screen image. Alternatively, photographs may be used by direction of the user. The mobile device can optionally prompt the user to take a particular view or allow the user to add a written description of the view. The mobile device can give the user an opportunity to retake the photograph. Alternatively, the mobile device can, e.g., provide a button on the screen to allow the user to choose to enter a photograph. The mobile device could also permit photographs to be added following the preset images or instead of the preset images. The use of photographs over preset images could eliminate the need to retain and/or maintain an updated database of the buckets and/or other capital products to be inspected. If photographs are used for the screen images, issues identified in the bucket could automatically be identified and entered into the system by visual recognition software. Close up photographs of the issues could be provided for this alternative. The user would preferably confirm, and correct as needed, that the automatically collected information was correct.

In one embodiment, the user inspects the bucket to determine if any parts of the bucket include issues, e.g., show deleterious effects such as the walls, lip or coupling flanges being worn, cracked and/or otherwise damaged. If an issue is found during the inspection, the operator, in this example, double taps that portion of the bucket image (or adjacent the bucket image) on any of the bucket images that corresponds to where the issue exists on the inspected bucket. The double tap causes a symbol or marker to show on the bucket image where the issue exists on the inspected bucket. A double tap is preferred to better distinguish from other touching on the screen such as swiping the display to move from one bucket image to another bucket image. Nevertheless, the symbols could be set by a single touching or other means by the user. In this example, a circular symbol 57 with a number 1 is shown on the upper front edge of the right sidewall 14 (FIG. 8). Other symbols could be used. For example, other shapes, sizes and/or indicia could be used, or other kinds of symbols such as arrows, other colored indications, etc. The symbol could be given a different color, size and/or shape to indicate the kind, severity and/or urgency in which the issues needs attention (e.g., maintenance, repair or replacement) as an aid to assessing the information and/or conducting the needed work on the bucket or other capital product.

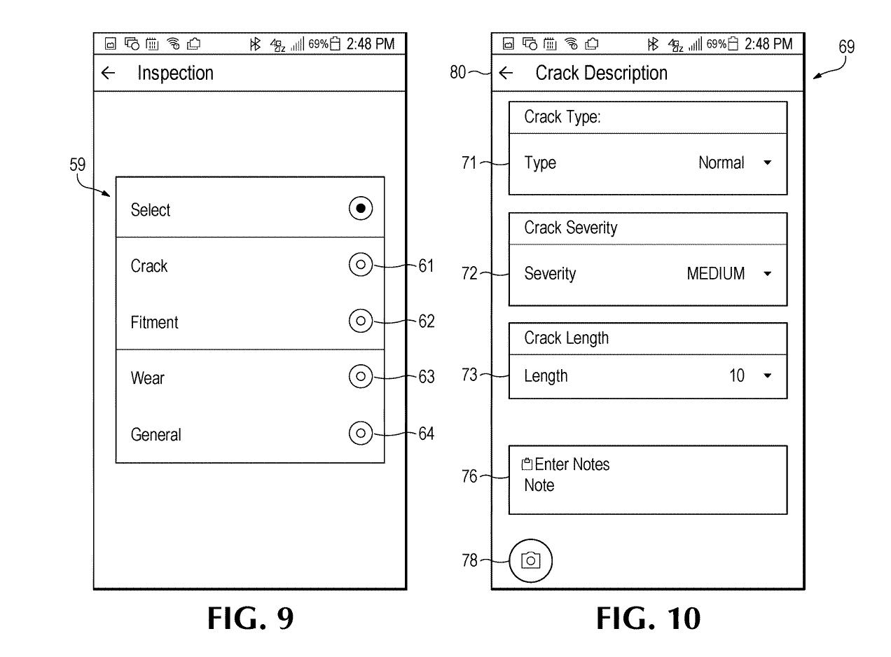

The user can input at least one characteristic of the issue through the human machine interface. Alternatively, the user could simply place the symbols where work is needed on the capital product. In such an alternative, the nature of the work needed could be outlined later by a manager, maintenance team, etc. In the present embodiment, a drop down list 59 is opened upon touching the observation button 60 on the touchscreen. Alternatively, drop down list 59 could open automatically with the user touching one of the bucket images 54. The list 59 can include a generic list of items that open regardless of where on the image the user touches the bucket image to indicate an issue, or it could include a custom list which varies depending on the part of the bucket image the user touches. In one example, drop down list 59 has selections 61-64 that include Crack 61, Fitment 62, Wear 63 and General 64 to indicate the kind or nature of issue that exists on the bucket (FIG. 9). As with the earlier screen image, selecting General 64 opens a window and keyboard (not shown) that enable the user to enter a description of the issue manually. Alternatively, a manual entry could be the only option or no manual entry could be provided as an option. In this example, once an issue is selected, a second drop down list 69 automatically opens (though it could be manually opened) that includes three drop down lists that are related to relevant details of the issue, which in this example is a cracking issue. In this example, the user inputs the crack type 71, crack severity 72 and crack length 73 through drop down lists (FIG. 10). Drop down list 69 could include a generic list regardless of which issue is selected or a custom list depending on which issue is selected. In this example, the user has identified that the crack is normal, of medium severity and 10 mm in length. A general selection (not shown) can also be included to permit, e.g., a manual note of, e.g., the severity of the issue or to note other information related to the issue. Other or additional selections for one or both drop down lists could be provided as well as additional drop down lists or windows for entering information on the noted issue on the inspected bucket. A notes window 76 for entering other comments is also provided in this example. Alternatively, all the information could be entered by the user without drop down lists. A camera button 78 can be provided on this (or other) screen image to permit the user to take one or more photographs and/or videos of the identified issue. The photograph is then associated with the issue identified by symbol 57. Once all the information has been entered for the first noted issue, the user touches the return button 80 (or by other means) to take the mobile device back to the last or first image of the bucket. Other arrangements for collecting and/or inputting the characteristics of the issue are possible.

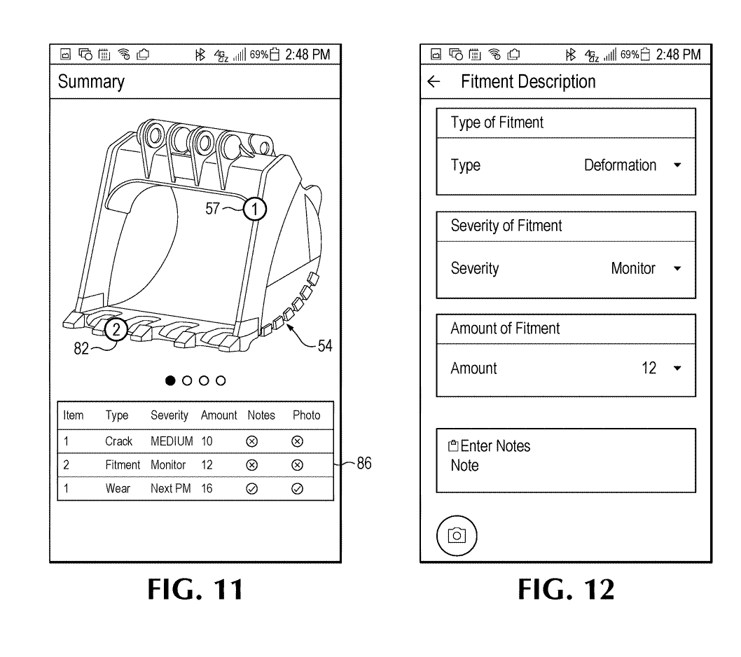

The user can then continue the inspection. If another issue is identified, the user touches the screen at the location on one of the bucket images that corresponds to where the second issue is located on the inspected bucket. In this example, the user double taps the lip of the bucket on bucket image 54a. With this second double tapping of bucket image 54, a second symbol 82 with the number 2 appears on the display (FIG. 11). The same process described above with respect to the first identified issues is repeated for this second issue. The same process is repeated until all the issues have been identified. In this example, the user is guided to identify the type and severity of an issue. In this example, a fitment issue that is a deformation is noted that is identified as needing only monitoring at this time rather than repair (FIG. 12). The user may also add summary comments, photographs, and/or reports not associated with a particular symbol. FIG. 11 shows the screen image with one of the summary buttons 84 having been pushed. In this example, a table 86 is shown under one of the bucket images (in this example, it is the image with the first marker 57) that shows a summary of the issues marked by the inspector. Other ways of providing a summary could be used. The user could optionally be guided or permitted to provide other information on the noted issues.

In another embodiment, the user could be guided to walk step-by-step through an inspection process and to optionally enter information on the various steps. The mobile device could display the step-by-step procedure on the screen for the inspector to follow in inspecting the bucket or other capital product. For example, the inspector could move from screen to screen as the bucket is inspected. The inspector could swipe from screen to screen or move from screen to screen in a different way. Optionally, the inspector could press a button on the screen (or otherwise) to indicate the step was completed. Alternatively, the mobile device could optionally provide audible instructions for guiding the inspection. In one embodiment, the procedure may direct the inspector to inspect the front edge of the right sidewall for wear, cracks, etc. The mobile device could at the same time or in a successive screen display, show an image that includes the portion of the bucket to be inspected, which in this example would be the front edge of the right sidewall. The next successive screen may direct the inspector to inspect another portion of the bucket, such as the weld connecting the right sidewall with the rear wall. The mobile device could again at the same time or in a successive screen display, show an image that includes the portion of the bucket to be inspected so the image could be marked with an electronic symbol. Such a procedure could continue until the entire bucket had been inspected. The step-by-step procedure could be stored on the mobile device or stored elsewhere and accessed by the mobile device. Use of a step-by-step procedure can provide greater certainty that the entire capital product will be inspected, and/or that the inspection will be conducted in an efficient, systematic manner. A procedure could also be used to limit the inspection to certain areas of the bucket, based on previous inspections, to eliminate unnecessary time inspecting other portions of the bucket or other capital product.

The mobile device and/or remote device can generate a report or documentation of the bucket inspection. The report could, for example, be accessed by a maintenance group to ensure all the work (e.g., maintenance and/or repair) identified by the inspector are completed. Further, it is common for a maintenance group to simply work on all issues on a bucket brought in for work regardless of whether the repair is needed. This can lead to unnecessary work being done, which can increase costs and backlog in the maintenance group, and/or increase the time a bucket is out of operation. Having a complete report of the inspected bucket made contemporaneously with the inspection assists in avoiding needed work being overlooked. The mobile and/or remote device can also maintain a record or history of inspections to provide a better understanding of how the operations and/or maintenance or repair cycles affect costs, lifespan and/or operations. Documenting and understanding the history can also be used to estimate or schedule timetables for future inspections and/or maintenance.

In some embodiments, these processes and systems can improve decision making for parts management and equipment maintenance. For example, having accurate and complete records of bucket inspections can assist managers in determining factors pertaining to operations including, for example, a purchase schedule for replacement parts, the scheduling of maintenance and/or repair of the bucket, anticipating costs and/or the number of personnel needed to conduct maintenance and/or repairs, estimating the number of buckets needed for an operation based on an expected maintenance and/or repair cycle, and the like.

In some embodiments, these processes and systems can collect data that is too often not gathered and documented with respect to a bucket. The data can be aggregated, summarized and analyzed to better understand how the operations affect the buckets, their downtime, lifespans, upkeep costs and the like. The collection and documenting of bucket inspections can improve visibility of costs, personnel use, etc. to key decision makers, which can lead to a more efficient operations.

In some embodiments, these processes and systems can reduce the work required to perform inspections. The inspector may only need a mobile device (e.g., a mobile phone) with, for example, the appropriate mobile app to conduct the inspections. In the case of a mobile phone, the user may already be carrying the device for other uses. In such cases, there would be no papers to carry and keep track of. Such a process could also eliminate the need for subsequent reports to be created from the inspection notes as the system could generate the reports from the information collected by the mobile device. As a result, manual documentation and the need to transcribe handwritten notes could be eliminated. This could reduce the time needed and improve the accuracy of the reports created. Standard reports could be easily created without significant time for preparation. Summaries could be provided on demand on web portals as needed.

In some embodiments, these processes and systems can improve work efficiencies. They can establish a standard method for collecting the data. They can provide reminders for regular or predicted critical inspections of the buckets. They can eliminate transcriptions and redundant data entry. Some of the embodiments can ease the export of data to other applications. Further, a single app on a mobile device can, for example, be used to inspect all kinds of buckets. It could also be used to inspect other kinds of capital products that need periodic maintenance and/or repair such as truck trays, ore chutes, etc. The inspection processes would be the same or similar for other capital products except, e.g., the produced images would be of the product to be inspected, the drop down lists may be custom to the product, etc.

In some embodiments, the processes and systems can improve asset management compliance. For example, they can standardize inspections based on conformance histories. Asset inspection history can be easily documented with less cost and time.

In some embodiments, the processes and systems can improve maintenance planning. For example, product condition and inspection data can drive the parts maintenance schedule. The collected data can be used in predictive analytics to ensure critical observations are managed and planned.

1. A process for managing a capital product for an earth working operation, the process comprising:
displaying an image of the capital product on a screen of a mobile device;
inspecting the capital product to identify an issue on the capital product;
placing an electronic symbol on the image to indicate where the identified issue is located on the capital product;
inputting at least one characteristic of the identified issue into the mobile device; and
electronically storing the image with the symbol and the characteristic for later use.

2. The process of claim 1 including taking a photograph of the capital product and using the photograph as the displayed image.

3. The process of claim 1 wherein the displayed image is a preset image from a storage medium.

4. The process of claim 1 including touching the screen with the image to provide the symbol where the screen is touched.

5. The process of claim 4 wherein the symbol is placed on the image at a location on the image that corresponds to the location where the issue was identified on the capital product.

6. The process of claim 1 including using drop down lists on the screen to input the at least one characteristic.

7. The process of claim 1 wherein the identified issue pertains to wear and/or damage of the capital product.

8. The process of claim 1 wherein the identified characteristic includes information pertaining to the kind of issue identified during the inspection.

9. The process of claim 8 wherein the identified characteristic includes information pertaining to details of the issue.

10. The process of claim 1 including using the stored image and characteristic to identify the location and kind of issue on the capital product, and making a determination of work to be done on the capital product.

11. The process of claim 10 including scheduling the work on the capital equipment.

12. The process of claim 1 wherein the mobile device displays a step-by-step procedure on the screen for identifying different portions of the capital product to be inspected.

13. The process of claim 12 wherein the symbol is placed on the screen while following the step-by-step procedure.

14. The process of claim 1 wherein the mobile device electronically stores a time stamp for the inspection.

15. The process of claim 1 wherein photographs and/or videos of the issue on the capital product are electronically stored and associated with the symbol on the image.

16. The process of claim 1 including a plurality of different images of the capital product each selectively viewed on the screen of the mobile device, and providing the symbol on any of the images.

17. The process of claim 16 wherein a second issue is identified on the capital product and successively identified with a second electronic symbol on a image that is different than the first-mentioned symbol.

18. The process of claim 1 wherein a second issue is identified on the capital product and successively identified with a second electronic symbol at a location on the image that is different than the location of the first-mentioned symbol.

19. The process of claim 1 wherein a plurality of issues are identified on the capital product, one said symbol is placed on the image for each said issue with each said symbol being different, and each said symbol being placed on the screen at a location that indicates the location of the issue on the capital product.

20. The process of claim 19 wherein a characteristic of the issue is inputted into the mobile device for each said issue, and each said characteristic is electronically stored to be associated with the symbol associated with the same issue.

21. The process of claim 1 wherein the characteristic is electronically stored to be in association with the symbol associated with the issue.

22. The process of claim 1 wherein programmable logic analyzes the electronically stored image and the characteristic, and issues an alert when work on the capital equipment is needed within a prescribed timeframe.

23. A process for managing a capital product for an earth working operation, the process comprising:
inspecting the capital product to identify an issue on the capital product;
displaying an image of the capital product on a screen of a mobile device;
placing an electronic symbol on the screen with the image to indicate where the identified issue is located on the capital product; and
electronically storing the image with the symbol.

24. The process of claim 23 including inputting into the mobile device and electronically storing a characteristic of the identified issue.

25. A process for managing a capital product for an earth working operation comprising taking a photograph of the capital product, displaying the photographic image on a screen of a mobile device, and placing an electronic symbol on the screen to correspond to an issue identified during an inspection of the capital product.

26. The process of claim 25 wherein a plurality of photographic images are taken and selectively displayed on the screen, and placing the electronic symbol on any of the images.

27. The process of claim 25 wherein at least one characteristic of the issue is electronically stored in association with the symbol on the image.

28. The process of claim 25 wherein the symbol is placed on the image.

29. A process for managing a capital product for an earth working operation, the process comprising:
using a mobile device to communicate instructions for inspecting the capital product;
inspecting the capital product by following the instructions to identify issues on the capital product;
displaying at least one image of the capital product on a screen of the mobile device;
placing an electronic symbol on the screen with the image to indicate where the identified issue is located on the capital product; and
electronically storing the image with the symbol for later use.

30. The process of claim 29 including inputting into the mobile device and electronically storing at least one characteristic of the identified issue.

31. The process of claim 29 wherein the inspection instructions are provided in successive steps with at least the one image of the capital product associated with at least a plurality of the steps with the option of placing an electronic symbol for identified issues.

32. The process of claim 31 including inputting into the mobile device and electronically storing at least one characteristic of each identified issue indicated by a symbol.

33. A system for inspecting a capital product, the system comprising:
a mobile device including a screen;
a processor having programmable logic to display an image of the capital product on the screen;
a human machine interface to input information for use by the processor to (i) display a symbol on the image at a location on the image that corresponds to the location of an issue on the capital product, and (ii) associate a characteristic of the issue with the symbol; and
a storage medium to electronically store the image with the symbol and the information regarding the characteristic associated with the symbol for later use.

34. The system of claim 33 including a camera to take a photograph of the capital product and using the photograph as the displayed image.

35. The system of claim 33 wherein the displayed image is a preset image from the storage medium.

36. The system of claim 33 wherein the human machine interface includes a touchscreen on the mobile device.

37. The system of claim 36 wherein the processor displays a symbol on the image by touching the screen where the screen is touched.

38. The system of claim 37 wherein the processor selectively displays a plurality of different images of the capital product each selectively viewed on the screen of the mobile device, and providing the symbol on any of the images.

39. The system of claim 38 wherein the processor enables viewing of the different images by swiping the screen.

40. The system of claim 36 wherein the processor provides drop down lists on the screen to enable inputting the at least one characteristic.

41. The system of claim 40 wherein the drop down lists provide characteristics to choose from that pertain to wear and/or damage of the capital product.

42. The system of claim 41 wherein the identified characteristic includes information pertaining to the kind of issue identified during the inspection.

43. The system of claim 42 wherein the identified characteristic includes information pertaining to details of the issue.
